(19) United States
(12) Patent Application Publication
(10) Pub. No.: US 2018/0032237 A1
(43) Pub. Date: Feb. 1, 2018

(54) SYSTEM AND METHOD OF ATTACHING A LINKED IMAGE AND SOUND TO CONTENT

(71) Applicant: Brittany Quinn Richards, Cincinnati, OH (US)

(72) Inventor: Brittany Quinn Richards, Cincinnati, OH (US)

(21) Appl. No.: 15/661,406

(22) Filed: Jul. 27, 2017

Related U.S. Application Data
(60) Provisional application No. 62/367,197, filed on Jul. 27, 2016.

(51) Int. Cl. G06F 3/0484; H04N 21/41; H04N 21/858; H04N 21/472; G06F 3/0481; G06F 3/14

(52) U.S. Cl. CPC G06F 3/04845; G06F 3/04817; G06F 3/14; H04N 21/858; H04N 21/47205; H04N 21/4126; H04N 21/47202; H04L 67/02

(57) ABSTRACT

A system and method for attaching a linked image and sound to content. A web server includes a database for storing data. The data includes a plurality of attachments each including a merged image and sound bite. Using a remote computer, a user may upload content including one of a video and a picture. The plurality of attachments are displayed to the user on the remote computer. The user is able to select one or more of the plurality of attachments via the user interface. The system then merges a selected attachment with the content forming a merged content. The merged content is saved to the database and displayed on the display device. The displaying of the merged content includes the video or picture, the image overlaid on a portion of the video or picture, and a playing of the sound bite at the same time.

### CROSS-REFERENCE TO RELATED APPLICATION

This application claims the benefit of priority of U.S. provisional application No. 62/367,197, filed Jul. 27, 2016, the contents of which are herein incorporated by reference.

### BACKGROUND OF THE INVENTION

The present invention relates to system and method of attaching a linked image and sound to content.

Currently, there is no way to add new content to existing content in a simplified manner where pre-existing content can be chosen and inserted. There is currently no platform that enables this derivative work to be shared and then modified.

As can be seen, there is a need for improved platforms that allow for attaching a linked image and sound to content.

### SUMMARY OF THE INVENTION

In one aspect of the present invention, a system for attaching a linked image and sound to content comprises: a web server comprising a database storing data comprising a plurality of attachments each comprising a merged image and sound bite; a remote computer connected to the web server over the Internet, the remote computer comprising a processor, a memory, a display device and a user interface, wherein the processor uploads a content comprising one of a video and a picture to the web server over the Internet; and displays the plurality of attachments of the database on the display device for a user to select one or more of the plurality of attachments via the user interface, wherein the system merges a selected attachment with the content forming a merged content, and displays the merged content on the display device, wherein the displaying of the merged content comprises the one of the video and the picture, the image overlaid on a portion of the one of the video and picture, and a playing of the sound bite.

These and other features, aspects and advantages of the present invention will become better understood with reference to the following drawings, description and claims.

### BRIEF DESCRIPTION OF THE DRAWINGS

FIG. 1 is a flow chart of an exemplary application of a system of the present invention;

FIG. 2 is a flow chart of an embodiment of the present invention;

FIG. 3 is a flow chart of an embodiment of the present invention;

FIG. 4 is a schematic view of an embodiment of the present invention; and

FIG. 5 is a schematic view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes the use of an emoji and other digital images plus a sound effect to be added to existing audio/visual content in a synchronous manner. The present invention allows users to interject thoughts at the point of relevance into pre-existing content. The present invention allows users to choose (or create their own) image and sound effect that can be inserted into pre-existing audio and/or video content using an application on a smart device. The present also allows for synchronous conveyance of this information with the pre-existing content.

The present invention includes a system and method for attaching a linked image and sound to content. The system includes a web server and a remote computer connected to the web server over the Internet. The web server includes a database for storing data. The data includes a plurality of attachments each including a merged image and sound bite. The remote computer includes a processor, a memory, a display device and a user interface. Using the remote computer, a user may upload content including one of a video and a picture to the system. The plurality of attachments are displayed to the user on the remote computer. The user is able to select one or more of the plurality of attachments via the user interface. The system then merges a selected attachment with the content forming a merged content. The merged content is saved to the database and displayed on the display device. The displaying of the merged content includes the video or picture, the image overlaid on a portion of the video or picture, and a playing of the sound bite at the same time.

In certain embodiments, the merged content is published on a social network web server by the user via the Internet. Other users may like the post, dislike the post, comment on the post and the like. The social media network web server may include, but is not limited to, FACEBOOK™, MYSPACE™, TWITTER™, INSTAGRAM™, SNAPCHAT™ and the like. In certain embodiments, the social network web server may include a social network server specifically created to be used with the present invention.

The system of the present invention may further include a generation module. In such embodiments, the database of the web server includes a first data package storing a plurality of images and a second data package storing a plurality of sound bites. The generation module displays the plurality of images and the plurality of sound bites on the display device of the remote computer. The generation module further prompts the user to combine one of the plurality of images with one of the plurality of sounds bites forming a custom attachment. The custom attachment is saved to the database and displayed with the plurality of attachments on the display device for the user to select.

In certain embodiments, the images of the present invention may be an emoji or other digital image. Emojis are ideograms and smileys used in electronic messages and Web pages. Emoji are used much like emoticons and exist in various genres, including facial expressions, common objects, places and types of weather, and animals. Digital Images may include clips of videos, photos, and other digital content both static and/or dynamic.

In alternate embodiments, the present invention may be used in the medical field to provide instruction video or for the collaboration of content. The present invention may also provide content that news channels may want to use and also provides the ability to train or point out a mistake. The present invention may also be added to digital documents in Virtual Reality and Games to add context to the information being provided. The key is adding both image and sound to content at the exact relevant moment.

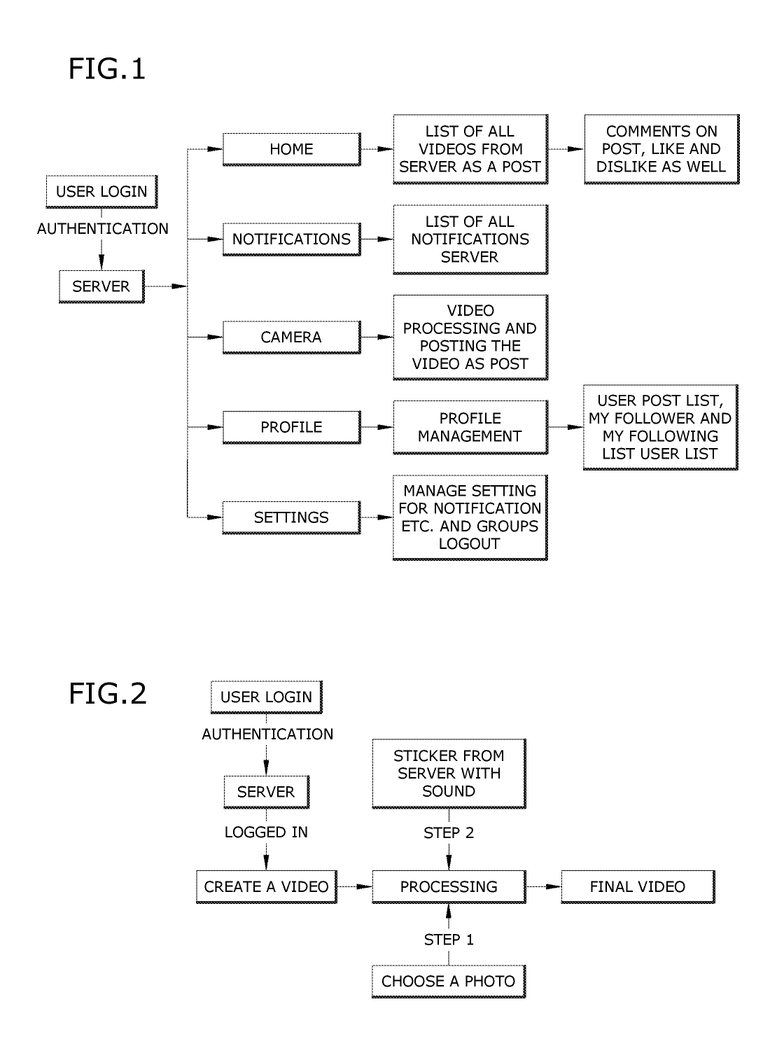

Referring to FIG. 1, the remote computer may access the web server via the Internet using an application loaded on the memory of the remote computer. In such embodiments, the remote computer is a tablet or a smart phone. The user may login to the application by entering a username and password, which is authenticated by the server. The application presents a home screen, a notification screen, a camera selector, a profile screen, and a settings screen. The home screen provides a list of all the merged content, such as videos saved on the server as posts on the social networks. The notifications page provides a list of all notifications that the server provides. The camera selector allows users to produce content, merge the content with the attachments and post the merged content on the social media network web server. The profile screen allows users to manage their profile. For example, the profile screen may allow users to pick who they would prefer to follow and not follow on the social media network web server. The settings screen allows users to manage their settings for notifications and groups logout.

FIG. 2 illustrates a flow chart for the camera selector function of the application. The user may create or upload content, such as a video or picture. The user may select an attachment including an image and sound. The processor of the server or the remote computer may merge the content with the attachment to produce the final merged content, such as a video or picture with the overlaid image and sound.

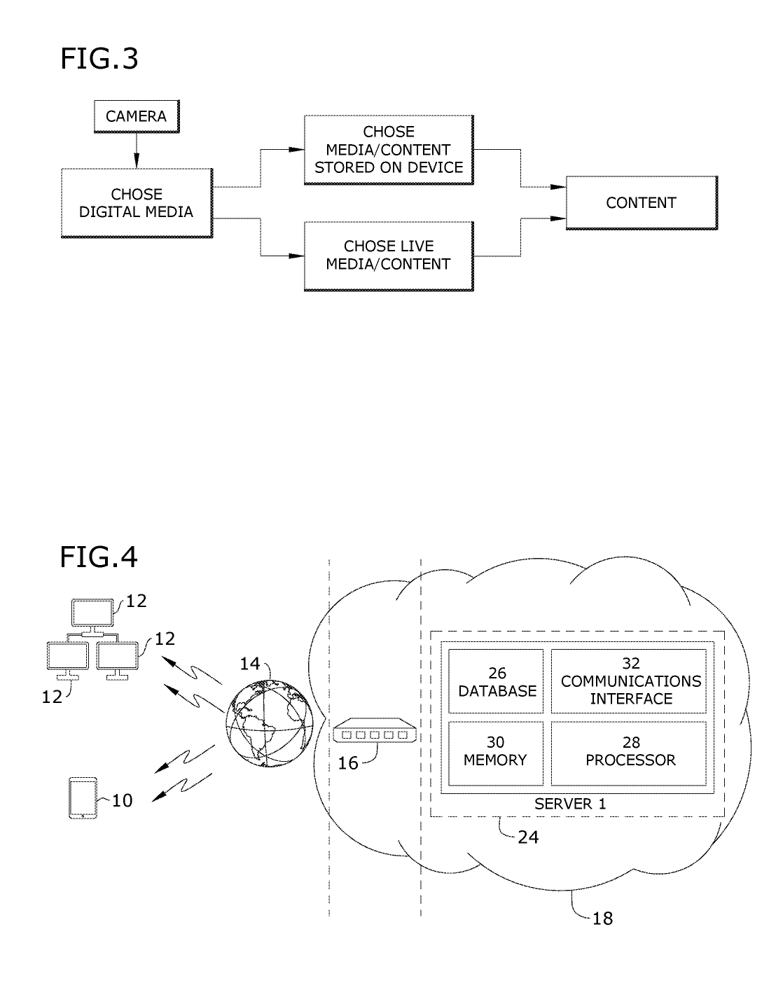

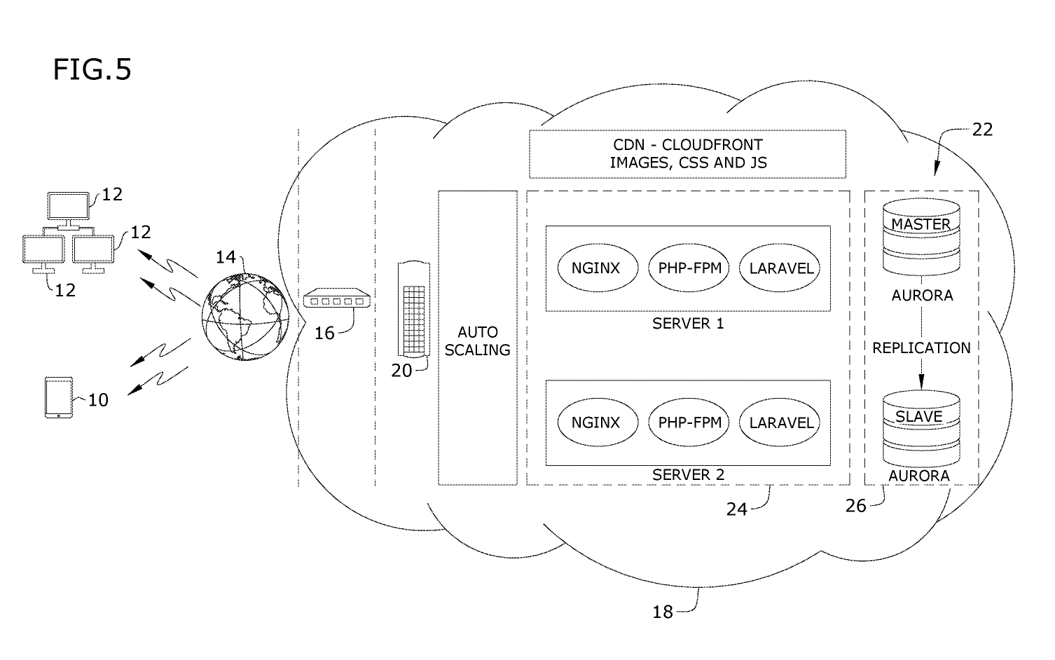

Referring to FIG. 3, the remote computer of the present invention may include a camera. The camera allows users to capture content and save the content directly to the memory of the remote computer. The user may either choose content directly saved on the memory of the remote computer or the user may choose content from other web servers hosted via the Internet.

As mentioned above, the content may include a video. In such embodiments, the processor of the remote computer prompts the user to pause the video to view a frame of the video and displays the plurality of attachments of the database on the display device for a user to select one or more of the plurality of attachments to attach to the frame of the video via the user interface. The system then merges the selected attachment with the video forming a merged content. The merged content is displayed on the display device and includes playing the video, displaying the image overlaid on a portion of the frame of the video, and a playing of the sound bite while displaying the frame.

Referring to FIG. 4, the present invention includes the remote computer 10 connected to the server 18 using the Internet 14. The sever 24 may be protected by a firewall 16. The remote computer 10 may be used to post the merged content on a social network 12 using the Internet 14. The present invention may further include an electronic load balancer 20 and rds-aws management db services 22

The remote computer 10 is remote from the server and may include a smart device, such as a tablet or a smart phone. The remote computer 10 is not limited to a smart device and may include desktop, laptop and the like. The remote computer 10 includes a processor, a memory a display device and a user interface. The remote computer 10 may further include a camera and a speaker. The user interface includes hardware, software, or both providing one or more interfaces for communication between the remote computer 10 and the server 24. As an example and not by way of limitation, a user interface may include a keyboard, keypad, microphone, monitor, mouse, printer, scanner, speaker, still camera, stylus, touchscreen, trackball, video camera, another suitable device or a combination of two or more of these.

In certain embodiments, the server 24 may execute any suitable operating system such as IBM's zSeries/Operating System (z/OS), MS-DOS, PC-DOS, MAC-OS, WINDOWS, UNIX, OpenVMS, an operating system based on LINUX, or any other appropriate operating system, including future operating systems. In certain embodiments, the server 24 may be a web server running web server applications such as Apache, Microsoft's Internet Information Server™, and the like. The web server may be part of a cloud based network 18.

In particular embodiments, the server 24 includes a processor 26, a memory 30, a database 28 and a communications interface 32. In particular embodiments, the processor 26 includes hardware for executing instructions, such as those making up a computer program. The memory 30 is for storing instructions such as computer program(s) for the processor 26 to execute, or data for processor 26 to operate on. The database 28 includes mass storage for data. As an example and not by way of limitation, the database 28 may include an HDD, a floppy disk drive, flash memory, an optical disc, a magneto-optical disc, magnetic tape, a Universal Serial Bus (USB) drive, a solid-state drive (SSD), or a combination of two or more of these. The database 28 may include removable or non-removable (or fixed) media, where appropriate. The database 28 may be internal or external to server 24, where appropriate. In particular embodiments, the database 28 is non-volatile, solid-state memory.

The communication interface 32 includes hardware, software, or both providing one or more interfaces for communication (e.g., packet-based communication) between the server and one or more other computing systems or one or more networks. As an example and not by way of limitation, communication interface 32 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 32. As an example and not by way of limitation, the server 24 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the server 24 may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The server 24 may include any suitable communication interface 32 for any of these networks, where appropriate.

It should be understood, of course, that the foregoing relates to exemplary embodiments of the invention and that modifications may be made without departing from the spirit and scope of the invention as set forth in the following claims.

What is claimed is:

1. A system for attaching a linked image and sound to content comprising:
a web server comprising a database storing data comprising a plurality of attachments each comprising a merged image and sound bite;
a remote computer connected to the web server over the Internet, the remote computer comprising a processor, a memory, a display device and a user interface, wherein the processor
uploads a content comprising one of a video and a picture to the web server over the Internet; and
displays the plurality of attachments of the database on the display device for a user to select one or more of the plurality of attachments via the user interface, wherein the system
merges a selected attachment with the content forming a merged content, and
displays the merged content on the display device, wherein the displaying of the merged content comprises the one of the video and the picture, the image overlaid on a portion of the one of the video and picture, and a playing of the sound bite.

2. The system of claim 1, wherein the plurality of images are a plurality of emojis.

3. The system of claim 1, wherein the merged content is published on a social network web server via the Internet.

4. The system of claim 1, wherein the web server merges the selected image and the content and the remote computer displays the merged content on the display device.

5. The system of claim 1, wherein the remote computer comprises a camera, wherein the content is captured by the camera of the remote computer.

6. The system of claim 1, further comprising a generation module, wherein the database of the web server comprises a first data package comprising a plurality of images and a second data package comprising a plurality of sound bites, wherein the generation module displays the plurality of images and the plurality of sound bites on the display device of the remote computer, and
prompts the user to combine one of the plurality of images with one of the plurality of sounds bites forming a custom attachment, wherein
the custom attachment is saved to the database and displayed with the plurality of attachments on the display device for the user to select.

7. The system of claim 1, wherein the remote computer accesses the web server via the Internet using an application loaded on the memory.

8. The system of claim 1, wherein the remote computer is a smart device comprising one of a tablet and a smart phone.

9. The system of claim 1, wherein the content comprises the video.

10. The system of claim 9, wherein the processor
prompts a use to pause the video to view a frame of the video,
displays the plurality of attachments of the database on the display device for a user to select one or more of the plurality of attachments to attach to the frame of the video via the user interface, wherein the system
merges a selected attachment with the video forming a merged content; and
displays the merged content on the display device, wherein the displaying of the merged content comprises playing the video, displaying the image overlaid on a portion of the frame of the video, and a playing of the sound bite while displaying the frame.
